(19) United States
(12) Patent Application Publication
(10) Pub. No.: US 2008/0053118 A1
(43) Pub. Date: Mar. 6, 2008

(54) Water-cooled air conditioner and method of controlling the same

(75) Inventors: In Woong Park, Changwon-si (KR); Ja Hyung Koo, Changwon-si (KR); Seung Cheol Baek, Changwon-si (KR); Soo Yeon Shin, Gimhae-si (KR); Dong Hyuk Lee, Changwon-si (KR)

Correspondence Address: MCKENNA LONG & ALDRIDGE LLP, 1900 K STREET, NW, WASHINGTON, DC, 20006, US

(73) Assignee: LG ELECTRONICS INC., Seoul (KR)

(21) Appl. No.: 11/790,270

(22) Filed: Apr. 24, 2007

(30) Foreign Application Priority Data
Sep. 1, 2006 (KR) 10-2006-0084041

(51) Int. Cl. G01K 13/00; F28F 9/26

(52) U.S. Cl. 62/129; 165/134.1

(57) ABSTRACT

A water-cooled air conditioner and a method controlling the same are provided. The water-cooled air conditioner includes a first heat exchanger where indoor air is heat-exchanged with refrigerant, a compressor for compressing the refrigerant, a plate-shaped second heat exchanger where the refrigerant compressed by the compressor is heat-exchanged with the water, and a freeze-crack preventing unit that is provided at a side of the second heat exchanger to prevent the water in the second heat exchanger from freezing.

### BACKGROUND OF THE INVENTION

1. Field of the Invention

The present invention relates to a water-cooled air conditioner, and more particularly, a water-cooled air conditioner that is designed to prevent water flowing along an internal passage of a heat exchanger from freezing by employing a freeze-crack preventing unit at a side of a heat-exchanger.

2. Description of the Related Art

Generally, an air conditioner is designed to reduce a temperature of an indoor space by (a) sucking warm indoor air, (b) heat-exchanging the warm indoor air with refrigerant, and (c) discharging the heat-exchanged air to the indoor space or to increase the temperature of the indoor space through a reverse cycle. The air conditioner provides a cooling/heating cycle in which the refrigerant circulates through a compressor, a condenser, and expansion valve, and an evaporator in this order.

Recently, as the quality of the life is improved and in response to the needs of the customers, in addition to the air cooling/heating function, the air conditioner also provides a variety of other functions such as an air cleaning function for discharging purified air into the indoor space after filtering off foreign objects contained in sucked air or a dehumidifying function for discharging dry air into the indoor space after changing humid sucked air into the dry air.

Meanwhile, the air conditioner is generally divided into an outdoor unit (called a heat discharge unit) installed at an outdoor space and an indoor unit (called a heat absorption unit) installed at an indoor space. The outdoor unit includes a condenser (a second heat exchanger) and a compressor and the indoor unit includes an evaporator (a first heat exchanger).

The air conditioner is generally classified into a split type air conditioner where the outdoor and indoor units are separately installed and an integral type air conditioner where the outdoor and indoor units are integrally installed. The split type air conditioner has been widely used due to its advantages in terms of an installation space and noise.

In order to reduce excessive power consumption during the air-conditioning of the indoor air, a water-cooled air conditioner has been actively used and developed.

Unlike a condenser (a second heat exchanger) of a conventional air-cooled air conditioner where the refrigerant is cooled by an outdoor air, the refrigerant of the water-cooled air conditioner is cooled by water. That is, the water and the refrigerant are not mixed with each other but separately pass through a second heat exchanger.

In the water-cooled air conditioner, as the water and the refrigerant separately flow along the water-cooled condenser (the second heat exchanger) without being mixed with each other, the water and the refrigerant are heat-exchanged with each other.

When the refrigerant and the water separately flow through the water-cooled condenser (second heat exchanger), the heat-exchange between the refrigerant and the water occurs in the water-cooled condenser.

When the water-cooled air conditioner in cold weather during winter is not operated, the water does not flow through the water-cooled condenser and thus the water may be frozen due to the low temperature of an external side.

When the water is frozen, no heat exchange is realized even when the air conditioner operates and thus the air conditioning is not realized. This causes the deterioration of the reliability of the product.

Furthermore, when the water is frozen, this causes the damage of the water-cooled condenser and thus the increase of the maintenance costs.

### SUMMARY OF THE INVENTION

Accordingly, the present invention is directed to a water-cooled air conditioner and a method of controlling the same that substantially obviate one or more problems due to limitations and disadvantages of the related art.

An object of the present invention is to provide a water-cooled air conditioner having a heating unit that is provided on a side of a heat exchanger, in which water and refrigerant are heat-exchanged with each other, and heats the second heat exchanger, thereby preventing the water from freezing.

Another object of the present invention is to provide a water-cooled air conditioner having a refrigerant recovering unit for directing refrigerant that is compressed to a high temperature/pressure state and heats the second heat exchanger, thereby preventing the water in the second heat exchanger from freezing.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a water-cooled air conditioner including: a first heat exchanger where indoor air is heat-exchanged with refrigerant; a compressor for compressing the refrigerant; a plate-shaped second heat exchanger where the refrigerant compressed by the compressor is heat-exchanged with the water; and a freeze-crack preventing unit that is provided at a side of the second heat exchanger to prevent the water in the second heat exchanger from freezing.

In another aspect of the present invention, there is provided a method of controlling a water-cooled air conditioner, comprising: detecting a temperature of water passing through the heat exchanger; comparing the detected temperature with a reference temperature; and preventing the water in the heat exchanger from freezing by selectively operating a freeze-crack preventing unit in accordance the comparison result.

According to the above-defined water-cooled air conditioner, a heating unit is further provided on a side of the second heat exchanger where the water and the refrigerant are heat-exchanged with each other.

In addition, a refrigerant recovering unit for directing the high temperature/pressure refrigerant from the compressor to the second heat exchanger and a cooling water temperature sensor for selectively operating the refrigerant recovering unit is provided on a side of the second heat exchanger.

Therefore, the freezing of the water in the second heat exchanger can be prevented and the frozen water can be melted by the refrigerant recovering unit that is selectively operated by the cooling water temperature sensor.

By the above-described advantage, the reliability of the product can be improved.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is an air view illustrating a state where a water-cooled air conditioner according to an embodiment of the present invention is installed in a building;

FIG. 2 is a view illustrating flows of air and water in a building when an integral type water-cooled air conditioner according to an embodiment of the present invention operates;

FIG. 3 is an air view illustrating a state where a multiple water-cooled air conditioner according to another embodiment of the present invention is installed in a building;

FIG. 4 is a perspective view of an outdoor unit of a water-cooled air conditioner according to an embodiment of the present invention;

FIG. 5 is an exploded perspective view of an internal structure of the outdoor unit of FIG. 4;

FIG. 6 is an enlarged view illustrating a freeze-crack preventing unit according to an embodiment of the present invention;

FIG. 7 is a view illustrating flows of refrigerant and water during an air cooling operation of a water-cooled air conditioner according to an embodiment of the present invention;

FIG. 8 is a view illustrating flow of refrigerant when a refrigerant recovering unit operates of a water-cooled air conditioner according to an embodiment of the present invention;

FIG. 9 is a block diagram of a method for controlling a water-cooled air conditioner according to an embodiment of the present invention; and

FIG. 10 is a view illustrating flows of refrigerant and water during an air heating operation of a water-cooled air conditioner according to an embodiment of the present invention.

### DETAILED DESCRIPTION OF THE INVENTION

Reference will now be made in detail to the preferred embodiments of the present invention, examples of which are illustrated in the accompanying drawings.

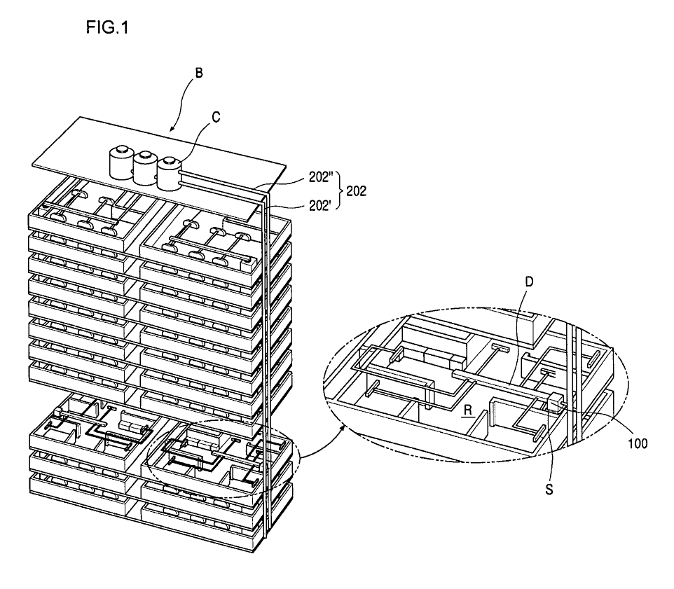

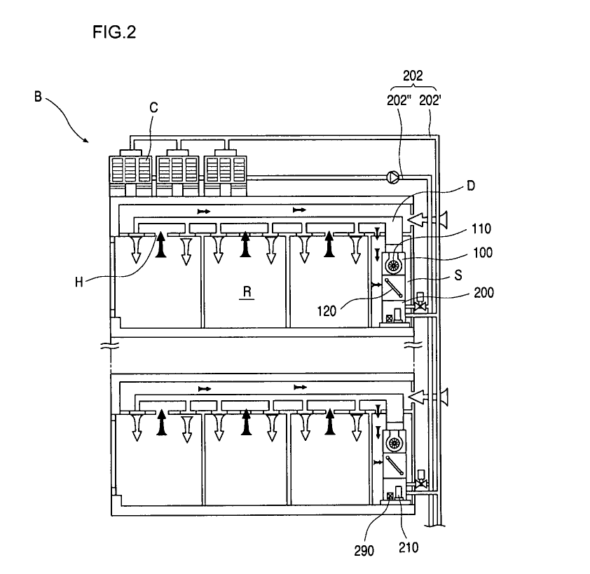

FIG. 1 shows an air view illustrating a state where a water-cooled air conditioner according to an embodiment of the present invention is installed in a building, and FIG. 2 is a view illustrating flows of air and water in a building when an integral type water-cooled air conditioner according to an embodiment of the present invention operates.

Referring to FIGS. 1 and 2, a water-cooled air conditioner is installed in an enclosed space S formed in a building B. The enclosed space S is completely isolated from an external side of the building B and communicates with an indoor space R through an air intake H formed through a ceiling to suck indoor air.

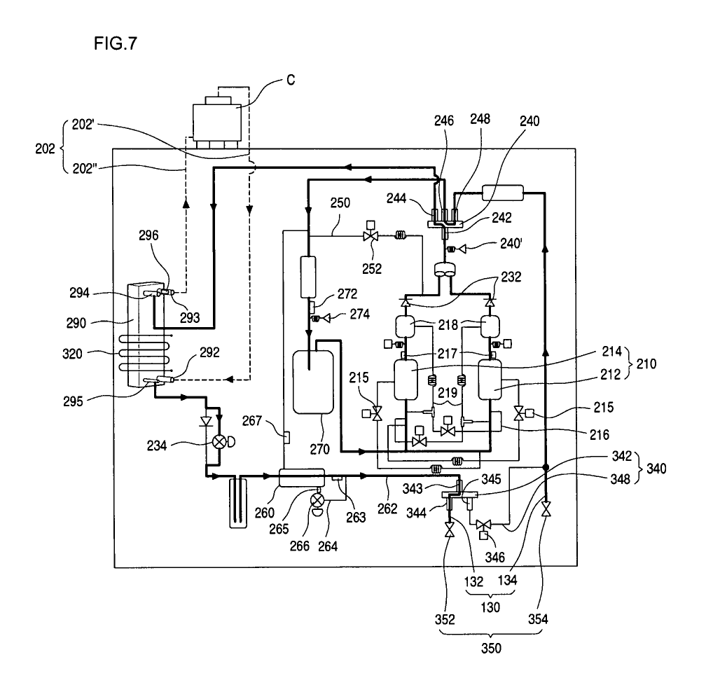

A duct D is connected to the indoor space R to allow air heat-exchanged by the water-cooled air conditioner to be discharged into the indoor space R. That is, the water-cooled air conditioner includes an indoor unit 100 for sucking the indoor air and discharging the indoor air after heat-exchanging the indoor air and an outdoor air 200 connected to the indoor unit 100 by a refrigerant pipe (130 of FIG. 7) and allowing the refrigerant introduced through the refrigerant pipe to be heat-exchanged with a water. The duct D allows the indoor unit 100 to communicate with the indoor space R.

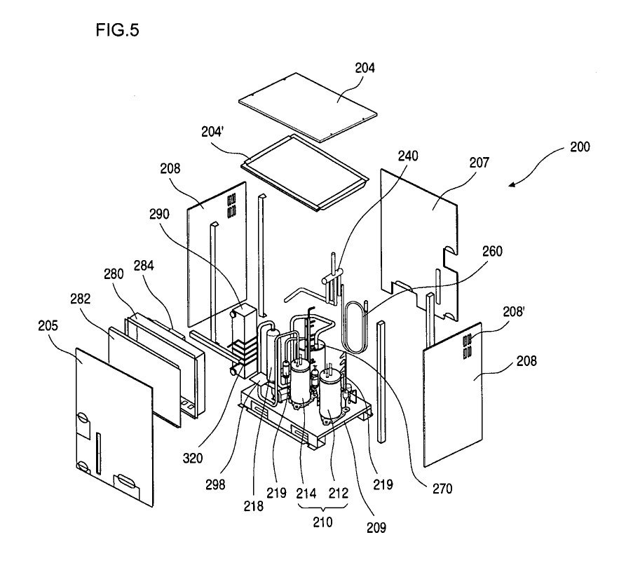

The outdoor unit 200 includes a compressor 210, an accumulator (270 of FIG. 5), a second heat exchanger 290, and an outdoor linear expansion valve (234 of FIG. 7). The indoor unit 100 includes a first heat exchanger 120 and an expansion valve (not shown).

When the water-cooled air conditioner operates, the indoor air is introduced into the indoor unit 100 through the air intake H formed in the ceiling of the building.

For this indoor air circulation, an indoor fan 110 for making an indoor air current is installed in the indoor unit 100. In addition, the first heat exchanger 120 is installed to be inclined at a lower side of the indoor fan 110.

The first heat exchanger 120 is provided to heat-exchange the indoor air using the refrigerant flowing inside the first heat exchanger 120. The first heat exchanger 120 is connected to the second heat exchanger 290 by the refrigerant pipe 130.

The refrigerant pipe 130 is designed to circulate the refrigerant between the indoor and outdoor units 100 and 200. A common liquid pipe (132 of FIG. 7) along which a liquid-phase refrigerant flows and which is a single pipe and a common gas pipe (134 of FIG. 7) along which a gas-phase refrigerant flows and which is a single pipe are provided between the indoor and outdoor units 100 and 200.

That is, the common liquid pipe 132 connects the second heat exchanger 290 to the first heat exchanger 120 and the common gas pipe 134 connects the compressor 210 to the first heat exchanger 120.

Although the installing location of the indoor unit 100 may vary depending on a type of the water-cooled air conditioner (integral type or split type), an internal structure thereof is almost identical to that of a conventional indoor unit. Therefore, a detailed description of the indoor unit 100 will be omitted herein.

The outdoor unit 200 of the outdoor unit 200 is provided under the indoor unit 100. The compressor 210 of the outdoor unit 200 compresses the refrigerant to a high temperature/pressure state. The second heat exchanger 290 of the outdoor unit 200 allows the refrigerant introduced from the compressor 210 to be heat-exchanged with water directed from a cooling tower C installed on, for example, a top of a building B. The second heat exchanger 290 is provided with a waterway 202 communicating with an inside of the cooling tower C. The waterway 202 includes a water inflow passage 202′ for directing the water from the cooling tower C to the second heat exchanger 290 and a water outflow passage 202″ for directing the water, which is heat-exchanged with the refrigerant while passing through an inside of the second heat exchanger 290, into the cooling tower C.

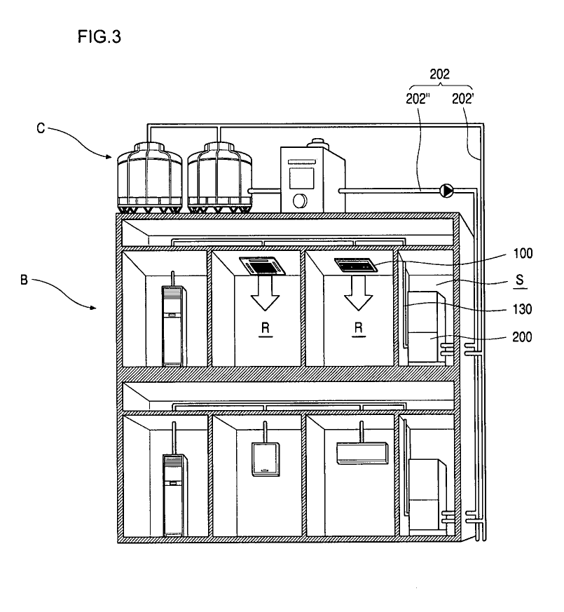

The following will describe a case where a multiple water-cooled air conditioner is applied with reference to FIG. 3. FIG. 3 is an air view illustrating a state where a multiple water-cooled air conditioner according to another embodiment of the present invention is installed in a building.

As shown in FIG. 3, when the water-cooled air conditioner is provided as a multiple type, the indoor and outdoor units 100 and 200 are separated from each other and connected by a refrigerant pipe 130. That is, the indoor unit 100 is installed on the ceiling of the indoor space R, and the outdoor unit 200 is installed in the enclosed space S. The indoor and outdoor units 100 and 200 are connected to each other by the refrigerant pipe 130 so that the refrigerant can circulate and allow the indoor air to be heat-exchanged.

A first heat exchanger (not shown) by which the indoor air is heat-exchanged with the refrigerant is provided in the indoor unit 100. An indoor fan 110 is further provided to allow the heat-exchanged air to be discharged into the indoor space R.

Like the integral type water-cooled air conditioner, the multiple water-cooled air conditioner includes a second heat exchanger for allowing the refrigerant to be heat-exchanged with the water. Since the circulations of the refrigerant and water in the second heat exchanger is identically realized to the integral type water-cooled air conditioner, a detailed description thereof will be omitted herein.

The following will describe the outdoor unit 200 of the multiple water-cooled air conditioner by way of example.

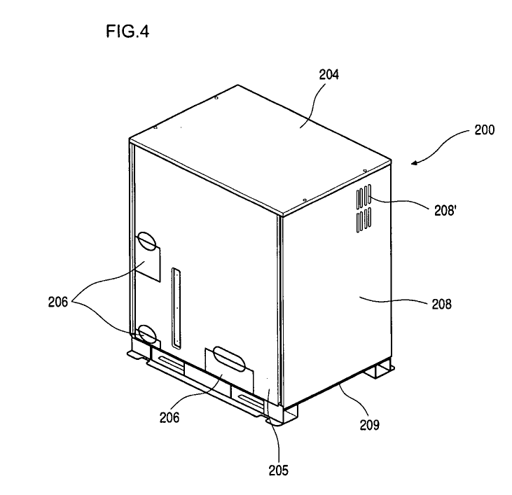

FIG. 4 is a perspective view of an outdoor unit of a water-cooled air conditioner according to an embodiment of the present invention, and FIG. 5 is an exploded perspective view of an internal structure of the outdoor unit of FIG. 4.

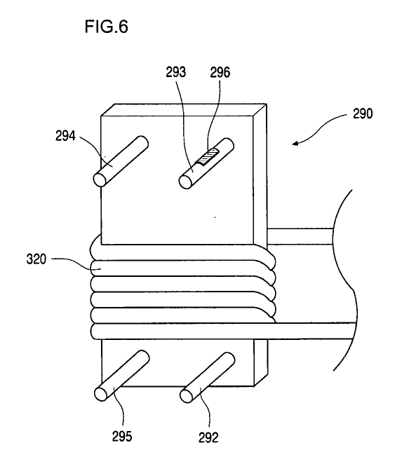

In addition, FIG. 6 is an enlarged view illustrating a freeze-crack preventing unit according to an embodiment of the present invention, and FIG. 7 is a view illustrating flows of refrigerant and water during an air cooling operation of a water-cooled air conditioner according to an embodiment of the present invention.

Referring to FIGS. 4 through 7, the outdoor unit 200 includes a top cover 204 formed in a rectangular parallelepiped and dividing the indoor unit 100 and the outdoor unit 200 from each other, front and rear panels 205 and 207 that define respectively front and rear outer appearances, side panels 208 that define left and right outer appearances, and a base pan 209 for supporting a plurality of components.

The top cover 204 is located at a top of the outdoor unit 200 to prevent the air passing through the indoor unit 100 from being introduced into the outdoor unit 200. That is, the top cover 204 is formed in a rectangular plate in which no hole is formed.

The top cover 204 also functions to support the indoor unit 100 provided thereon. Therefore, the top cover 204 is provided at a bottom edge with a reinforcing beam 204′ for reinforcing strength thereof.

The front panel 205 is erected under a front end of the top cover 204. Service panels 206 are formed at a central left side and a lower left/right side of the front panel 205. The service panels 206 are provided to open an internal side of the outdoor unit 200 when a maintenance service is required due to a malfunctioning of a component installed in the outdoor unit 200. Each of the service panels 206 is provided with slits except for one side.

Therefore, the service panels 206 pivot with reference to a side where no slit is formed to allow the internal space of the outdoor unit 200 to communicate with an external side, thereby allowing for the maintenance service.

The side panels 208 contacts rear-left and rear-right ends of the front panel 205. Each of the side panels 208 is provided at an upper portion with a plurality of heat dissipation holes 208′ through which the heat generated by the operation of the compressor is dissipated to the external side.

Although not shown in the drawings, the top cover 204, the front panel 205, the rear panel 207, and the side panel 208 may be provided with connection holes through which the common gas pipe 134 and the common liquid pipe 132 are connected to the indoor unit 100.

The base pan 209 is provided to contact lower ends of the front, rear, and side panels 205, 207, and 208. The base pan 209 is provided to support a plurality of components. Particularly, the compressor 210 is provided on a top center of the base pan 209.

The compressor 210 is designed to compress the refrigerant to a high temperature/pressure state. The compressor 210 is provided at left and right sides. That is, the compressor 210 includes a constant speed compressor 212 operated with a constant speed and installed at a relatively right side and an inverter compressor 214 that is a variable speed heat pump installed at a left side of the constant speed compressor 212 and operated with a variable speed.

A refrigerant sprayer 215 is installed at an inlet of the compressor 210. The refrigerant sprayer 215 is provided to spray the refrigerant to the compressor 210 when the compressor 210 is over-heated during the operation, thereby preventing the compressor 210 from being damaged.

A uniform fluid pipe 216 is installed between the constant speed compressor 212 and the inverter compressor 214 to communicate the constant speed compressor 212 and the inverter compressor 214 with each other. Therefore, when one of the compressors 212 and 214 is short of fluid, the fluid of the other is directed to the compressor that is short of the fluid, thereby preventing the compressor 210 from being damaged.

A scroll compressor where noise is not so intrusive may be used as the compressor 210. Particularly, an inverter scroll compressor that is controlled in an RPM depending on a load capacity may be used as the inverter compressor 214.

Therefore, when a load applied to the compressor 210 is low, the inverter compressor 214 first operates. Then, as the load capacity applied to the compressor 210 gradually increases and thus the inverter compressor 214 is unequal to the increased load capacity, the constant speed compressor 212 operates.

The compressor 210 is provided at an outlet side with a compressor discharge temperature sensor 217 for detecting a temperature of the refrigerant discharged from the compressor 210 and an oil separator 218. The oil separator 218 filters oil mixed in the refrigerant discharged from the compressor 210 and allows the filtered oil to be returned to the compressor 210.

That is, the oil used for cooling the frictional heat generated during the operation of the compressor 210 is discharged together with the refrigerant through an outlet of the compressor 210.

The oil separator 218 is provided at an outlet with a check valve 232 for preventing the refrigerant from flowing back. That is, when only one of the constant speed compressor 212 and the inverter compressor 214 operates, the check valve 232 prevents the refrigerant from flowing into the other of the compressors.

The oil separator 218 is designed to communicate with a four-way valve 240 by a pipe. The four-way valve 240 is provided to convert the flow of the refrigerant according to an operation mode (cooling or heating mode) of the air conditioner. The four-way valve 240 includes an inlet port 242, a first outlet port 244, a second outlet port 246, and a third outlet port 248. The ports are connected to an outlet of the compressor 210 (or the oil separator 218), an inlet of the compressor 210 (or an accumulator 270), the second heat exchanger 290, and the indoor unit 100, respectively.

Therefore, the refrigerant discharged from the inverter compressor 214 and the constant speed compressor 212 is collected in a location and then directed to the four-way valve 240. The four-way valve 240 is provided at an outlet with a high pressure sensor 240′ for detecting the pressure of the refrigerant discharged from the compressor 210.

Meanwhile, a hot gas pipe 250 is installed bypassing the four-way valve 240 to allow a portion of the refrigerant introduced into the four-way valve 240 to be directly directed to the accumulator 270 that will be described in more detail later.

The hot gas pipe 250 is provided to directly direct the high pressure refrigerant of an outlet side of the compressor 210 to the inlet of the hot gas pipe 250 when there is a need to increase the pressure of the low pressure refrigerant introduced into the accumulator 270 during the operation of the air conditioner. A hot gas valve 252 is installed on the hot gas pipe 250 to open and close the hot gas pipe 250.

An over-cooler 260 is installed on a top-right-rear end of the base pan 209. The over-cooler 260 is provided to further cool the refrigerant that is heat-exchanged in the second heat exchanger 290. The over-cooler 260 is formed at a portion of the outdoor liquid pipe 262 connected to the outlet of the second heat exchanger 290.

The over-cooler 260 is formed in a dual-pipe structure. That is, the over-cooler 260 includes an inner pipe communicating with the outdoor liquid-phase pipe 262 and an outer pipe surrounding the inner pipe. A reverse transfer pipe 264 is branched off from the outlet of the over-cooler 260. The reverse transfer pipe 264 is provided with an over-cooler expansion valve 266 for cooling the refrigerant through an expanding process.

Then, a portion of the refrigerant discharged from the over-cooler 260 is introduced into the reverse transfer pipe 264 and cooled while passing through the over-cooler expansion valve 266. The cooled refrigerant flows back through the over-cooler 260 to be further cooled. The backflow refrigerant discharged from the over-cooler 260 is fed again to the accumulator 270 and circulated.

Meanwhile, the over-cooler 260 is provided at an outlet with a liquid pipe temperature sensor 263 for detecting the temperature of the refrigerant discharged from the outdoor unit 200. The over-cooler expansion valve 266 is provided at an outlet with an over-cooler inlet sensor 265 to detect the temperature of the backflow refrigerant inflowing the over-cooler 260. The reverse transfer pipe 264 along which the backflow refrigerant discharged from the over-cooler 260 is provided with an over-cooler outlet sensor 267.

Accordingly, the refrigerant passed through the second heat exchanger 290 flows through a central portion and the low temperature refrigerant expanding by the expansion valve (not shown) flows in an opposite direction at an outer side, thereby further lowering the temperature of the refrigerant.

The accumulator 270 is installed at a left portion of the base pan 209 (i.e., at a left side of the inverter compressor 214). The accumulator 270 functions to filter off the liquid-phase refrigerant and allow only the gas-phase refrigerant to be introduced into the compressor 210.

If the liquid-phase refrigerant that is directed from the indoor unit 100 and is not vaporized is directly introduced into the compressor 210, the compressor 210 for compressing the refrigerant to a high temperature/pressure gas-phase state is overloaded and thus damaged.

Therefore, since the liquid-phase refrigerant that is introduced into the accumulator and is not vaporized is relatively heavier than the gas-phase refrigerant, the liquid-phase refrigerant is settled down at a lower portion of the accumulator 270 and only the gas-phase refrigerant is introduced into the compressor 210.

The accumulator 270 is provided at an inlet with an intake pipe temperature sensor 272 for detecting the temperature of the refrigerant introduced therein and a low pressure sensor 274.

Meanwhile, a control box 280 is installed in rear of the front panel 205. The control box 280 is formed in a rectangular parallelepiped and is selectively closed by a control cover 282 pivotally fixed on a top end of the control box 280.

Control components such as a voltage transformer, a printed circuit board, and a capacitor are provided in the control box 280 and a heat dissipation unit 284 formed with heat dissipation fins are formed on a rear surface of the control box 280.

The second heat exchanger 290 is provided at a rear side of the control box 280 to allow the refrigerant and the water to be heat-exchanged with each other while passing therethrough. The second heat exchanger 290 is formed in a rectangular parallelepiped.

A plurality of water flow pipes and refrigerant flow pipes are provided in the second heat exchanger 290 to prevent the refrigerant and the water from being mixed with each other. The water and refrigerant flow pipes are alternately arranged to be adjacent to each other so that the heat-exchange between the refrigerant and water can be effectively realized.

That is, the refrigerant flow pipes (not shown) are arranged to surround the water pipes (not shown) while the water pipes are arranged to surround the refrigerant flow pipes. Therefore, it will be preferable that the water and refrigerant pipes are designed to be identical in a sectional shape and size with each other.

For example, the water and refrigerant flow pipes are formed in a regular hexagonal shape so that they can be arranged in a honeycomb shape.

The second heat exchanger 290 is provided at a front surface with water inflow and outflow pipes 292 and 293 through which the water is introduced into or discharged from the second heat exchanger 290 and refrigerant inflow and outflow pipes 294 and 295 through which the refrigerant is introduced into or discharged from the second heat exchanger 290.

That is, the water inflow and outflow pipes 292 and 293 are formed on front-right upper and lower portions of the second heat exchanger 290 and extend into the second heat exchanger to guide the introduction and discharge of the water into or from the second heat exchanger 290. The water inflow pipe 292 is positioned under the water outflow pipe 293.

In addition, the refrigerant inflow and outflow pipes 294 and 295 are formed on front-left upper and lower portions of the second heat exchanger 290 and extend into the second heat exchanger 290 to guide the introduction and discharge of the refrigerant into or from the second heat exchanger 290. The refrigerant inlet pipe 294 is positioned under the water outflow pipe 295.

When the water and refrigerant are introduced into the second heat exchanger 290, the water flows from an upper side to a lower side along the water flow pipe disposed in the second heat exchanger 290. The refrigerant introduced into the second heat exchanger 290 flows from the lower side to the upper side along the refrigerant flow pipe.

As the water and the refrigerant flow in an opposite direction to each other in the second heat exchanger 290, the heat exchange efficiency between the water and the refrigerant may be maximized.

A cooling water temperature sensor 296 is provided at a side of the second heater exchanger 290, i.e., at a side of he water outflow pipe 293. The cooling water temperature sensor 296 is provided to detect the temperature of the water that is discharged through the water outflow pipe 293 after being heat-exchanged with the refrigerant in the second heat exchanger 290.

According to a feature of the present invention, a freeze-crack preventing unit is provided on an outer surface of the second heat exchanger 290. The freeze-crack preventing unit is provided to melt the frozen water in the second heater exchanger by selectively heating the second heat exchanger.

That is, the freeze-crack preventing unit generates selectively heat when the temperature of the water in the second heat exchanger is lower than a reference temperature, thereby preventing the water in the second heat exchanger 290 from freezing.

FIG. 6 illustrates an example of the freeze-crack preventing unit.

As illustrated in FIG. 6, the freeze-crack preventing unit includes a heating unit 320 that is wound around the second heat exchanger 290 as a heating unit 320 and generates when an electric power is applied. That is, the heating unit 320 is formed of a heating wire wound around a lower portion of the second heat exchanger 290. However, any heat generation member can be applied as the heating unit 320.

The heating unit 320 is designed to synchronize with the cooling water temperature sensor 296. That is, when the temperature of the water outflow pipe 293 (when it is regarded that the temperature of the water outflow pipe 293 is same as that of the water in the water outflow pipe 293) is lowered to 0° C., the cooling water temperature sensor 296 generates a signal and transmits the same to the printed circuit board. The printed circuit board applies the electric power to the heating unit 320.

Therefore, even when the water-cooled air conditioner is not used for many days and an outside temperature is lowered to be equal to or lower than 0° C., the damage of the second heat exchanger 290 due to the freezing of the water can be prevented.

Referring again to FIG. 5, a heat exchanger support 298 is provided under the second heat exchanger 290. The heat exchanger support 298 supports the second heat exchanger 290 such that the second heat exchanger 290 is spaced apart from the base pan 209.

That is, the top surface of the heat exchanger support 298 is slightly larger than the bottom surface of the second heat exchanger 290. A rear half of the heat exchanger support 298 is formed to extend and be inclined toward a lower-rear side from the top rear end.

In another embodiment, the freeze-crack preventing unit may be designed to prevent the freezing of the water in the second heat exchanger 290 by utilizing the heat of the refrigerant compressed in the compressor 210.

In more detail, as shown in FIG. 7, a refrigerant recovering unit 340 is provided as the freeze-crack preventing unit between an outdoor liquid-phase pipe 262 communicating with the second heat exchanger 290 and a common gas-phase pipe 262 communicating with an inside of the four-way valve 240.

Like the heating unit 320, the refrigerant recovering unit 340 is also designed to synchronize with the cooling water temperature sensor 296. That is, when the water temperature detected by the cooling water temperature sensor 296 is lowered to 0° C., the refrigerant recovering unit 340 converts the flow direction of the refrigerant discharged from the compressor 210 to direct the same to the second heat exchanger 290.

That is, the refrigerant recovering unit 340 includes a three-way valve 342 that is provided with three ports to convert the flow direction of the refrigerant and a refrigerant recovering pipe 348 that directs the refrigerant from the compressor 210 to the three-way valve 342 by being connected to one of the three ports.

In more detail, the three-way valve 342 includes an inlet port 343, a first outlet port 344, and a second outlet port 345. The ports 343, 344, and 345 are respectively connected to an outlet of the second heat exchanger 290, the outdoor unit 100, and the refrigerant recovering pipe 348.

Therefore, when the cooling water temperature sensor 296 transmits a signal to the printed circuit board, the printed circuit board controls the on/off of the ports of the three-way valve 342 in accordance with the signal. Therefore, the refrigerant discharged from the compressor 210 is directed to the second heat exchanger 290 via the three-way valve 342.

A recovering closing valve 346 for selectively closing the refrigerant recovering pipe 348 is provided on a side of the refrigerant recovering pipe 348. The recovering closing valve 346 is designed to close the refrigerant recovering pipe 348 when the water-cooled air conditioner operates with a cooling/heating mode. That is, the recovering closing valve 346 is provided to prevent the refrigerant discharged from the compressor 210 is directly introduced into the second heat exchanger 290 or the four-way valve 240 without passing through the indoor unit 100.

A thaw blocking valve 350 is provided each of ends of the first port 344 of the three-way valve 342 and the common gas-phase pipe 134. The thaw blocking valve 350 is selectively closed when the frozen water of the second heat exchanger 290 is melted by the cooling water recovering unit 340. The thaw blocking valve 350 includes a first blocking valve 352 for preventing the refrigerant discharged from the compressor 210 from being introduced into the indoor unit 100 and a second blocking valve 354 for preventing the refrigerant in the three-way valve from being introduced into the indoor unit 100.

Therefore, the first blocking valve 352 and the second blocking valve 354 are oppositely operated to the recovering closing valve 346. That is, when the first and second blocking valves 352 and 354 are closed, the recovering closing valve 346 is opened.

The following will describe an operation of the above-described water-cooled air conditioner with reference to FIGS. 7 through 10.

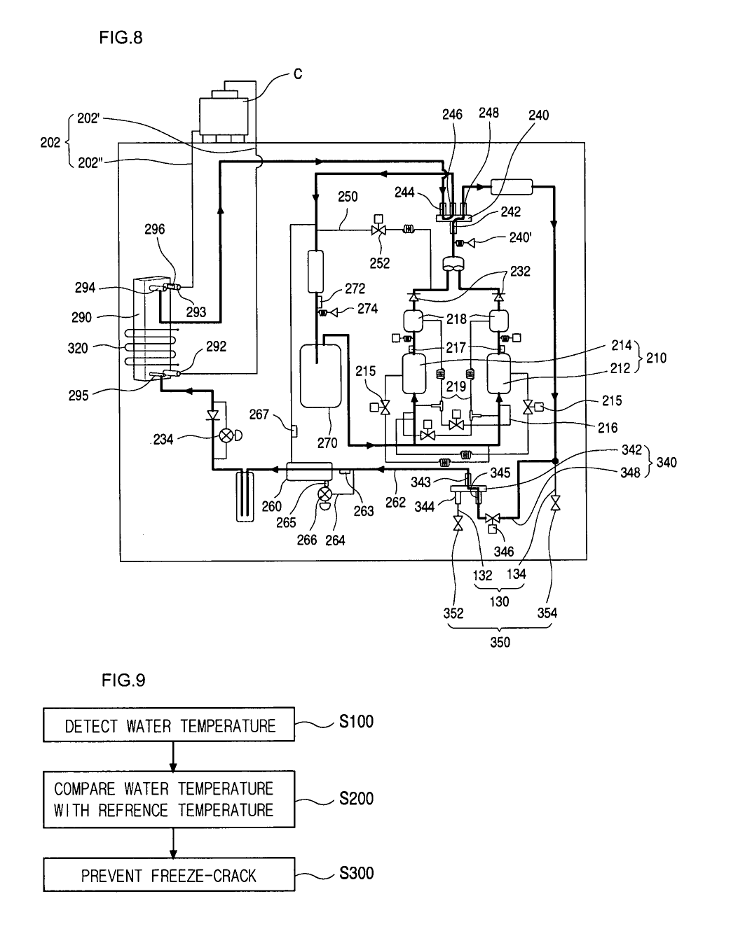

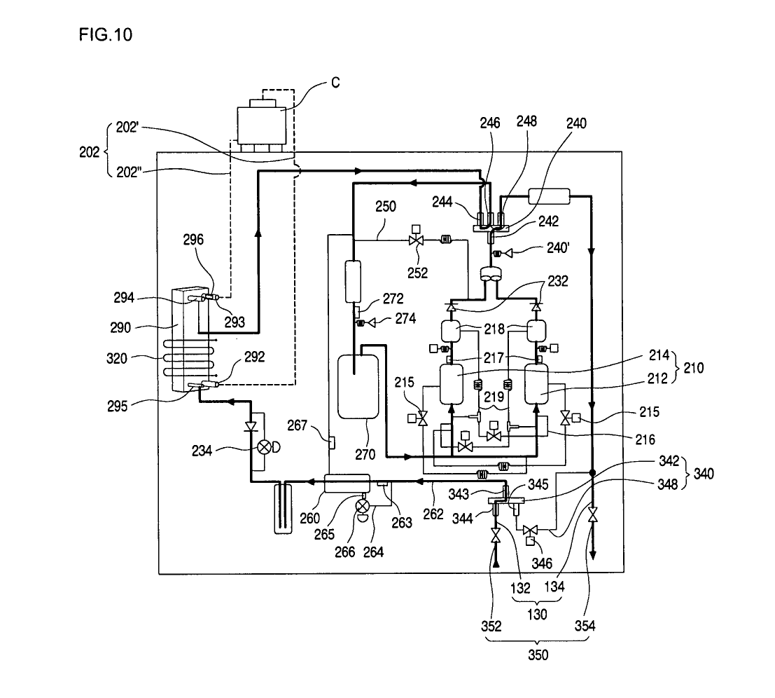

FIG. 8 is a view illustrating flow of refrigerant when a refrigerant recovering unit operates of a water-cooled air conditioner according to an embodiment of the present invention, FIG. 9 is a block diagram of a method for controlling a water-cooled air conditioner according to an embodiment of the present invention, and FIG. 10 is a view illustrating flows of refrigerant and water during an air heating operation of a water-cooled air conditioner according to an embodiment of the present invention.

The following will describe the refrigerant flow in the outdoor unit in the cooling mode operation of the air conditioner with reference to FIG. 7. In the cooling mode operation, the outdoor electronic valve 234 is opened to allow the refrigerant to flow between the outdoor unit 200 and the indoor unit 100.

Describing the refrigerant flow in the outdoor unit 200, the gas-phase refrigerant is introduced from the outdoor unit 100 into the four-way valve 240 through the third outlet port 248 and is directed to the accumulator 270 through the second outlet port 246 of the four-way valve 240. The gas-phase refrigerant coming out of the accumulator 270 goes into the compressor 210.

The refrigerant is compressed in the compressor 210 and discharged to pass through the oil separator 218. The oil contained in the refrigerant is separated and recovered into the compressor 210 through the oil recovery pipe 219.

That is, as the refrigerant is compressed in the compressor 210, it is mixed with the oil. At this point, since the oil is in a liquid-phase, it can be separated from the refrigerant by the oil separator 218 that is a gas/liquid separator.

Meanwhile, the oil in the compressor 210 is equalized by the uniform liquid pipe 216 connecting the constant speed compressor 212 to the inverter compressor 214.

Then, the refrigerant passing through the oil separator 218 is introduced into the four-way valve 240 through the inlet port 242 and is then directed to the second heat exchanger 290 through the first outlet port 244 of the four-way valve 240.

The discharged refrigerant is introduced into the second heat exchanger 290 through the refrigerant inflow pipe 294 and heat-exchanged with the water introduced from the cooling tower C into the second heat exchanger 290 through the water inflow pipe 292, thereby being converted into the liquid-phase refrigerant. Then, this liquid-phase refrigerant is directed to the over-cooler 260 to be further cooled.

At this same time, the water is wormed during the heat exchange with the refrigerant in the second heat exchanger 290 is discharged out of the second heat exchanger 290 through the water outflow pipe 293 and is then introduced into the cooling tower C through the water outflow passage 202′.

The water introduced into the cooling tower C is introduced again into the second heater exchanger 290 through the water inflow passage 202′. This process is continuously repeated.

Meanwhile, the refrigerant passing through the over-cooler 260 further passes through a drier where the moisture contained in the refrigerant is removed and is then introduced into the indoor unit 100. Then, the refrigerant is introduced into the three-way valve 342. At this point, the recovering closing valve 346 closes the refrigerant recovering pipe 348 and the thaw blocking valve 350 is opened.

Then, the refrigerant introduced into the three-way valve 342 is discharged through the first outlet port 344 and is then introduced into the indoor unit 100 through the common liquid-phase pipe 132. Then, the refrigerant is pressure-reduced by the expansion valve and heat-exchanged in the first heat exchanger 120. At this point, since the first heat exchanger 120 functions as an evaporator, the refrigerant is converted into a low pressure gas-phase through the heat exchange.

The refrigerant heat-exchanged while passing through the first heat exchanger 120 flows along the common gas-phase pipe 134 and is then introduced into the accumulator 270 via the four-way valve 240.

The accumulator 270 filters off the liquid-phase refrigerant so that only the gas-phase refrigerant can be fed to the compressor 210. By the above-described series of processes, one cooling cycle is completed.

The following will describe a method of controlling the water-cooled air conditioner using the freeze-crack preventing unit during winter with reference to FIGS. 8 and 9.

When the heating mode is selected, the cooling water temperature sensor 296 continuously operates to detect the water temperature in the second heat exchanger 290 (i.e., in the water outflow pipe 293 (S100).

A control unit compares the water temperature detected by the cooling water temperature sensor 296 with a reference temperature (0° C.) (S200). At this point, when it is determined that the water temperature detected by the cooling water temperature sensor 296 is equal to or lower than 0° C., this information is signalized and transmitted to the printed circuit board since the water in the second heat exchanger 290 may be frozen. Then, the printed circuit boar applies the electric power to the freeze-crack preventing unit (S300).

Then, the heating unit 320 generates heat to heat the second heat exchanger 290, thereby preventing the water in the second heat exchanger 290 from freezing.

In addition, the electric power is also applied to the recovering blocking valve 346 of the refrigerant recovering unit 340 to open the refrigerant recovering unit 348 so that the refrigerant compressed in the compressor 210 is directed to the second heat exchanger 290.

At this point, the second heat exchanger 290 takes heat from the high temperature/pressure refrigerant passing therethrough, thereby being heated and thus preventing the water therein from freezing.

The following will described the flow of the refrigerant in the thaw mode operation of the water-cooled air conditioner with reference to arrows of FIG. 8. The high temperature/pressure refrigerant discharged from the compressor 210 cannot be introduced into the indoor unit 100 as a second blocking valve 354 is closed but introduced into the refrigerant recovering pipe 348.

The refrigerant passing through the refrigerant recovering pipe 348 is introduced into the three-way valve 342 through the second outlet port 345 and is then discharged out of the three-way valve 342 through the inlet port, after which the refrigerant is introduced into the second heat exchanger 290 along the outdoor liquid-phase pipe 262.

Since the refrigerant introduced into the second heat exchanger 290 is in a hot state as it is compressed in the compressor 210, it heats the second heat exchanger 290 while passing through the second heat exchanger 290.

When the second heat exchanger 290 is heated by the refrigerant, the frozen water in the water flow pipe is thawed.

In addition, the frozen water in the second heat exchanger 290 can also be thawed by the heat unit 320. That is, the heating unit 320 heats the outer surface of the second heat exchanger 290 by being applied with the electric power depending on the water temperature detected by the cooling water temperature sensor 296. It is preferable that the heat unit 320 and the refrigerant recovering unit 340 are simultaneously operated.

As described above, when the frozen water in the second heat exchanger 290 is melted by the operation of the heating unit 320 and the refrigerant recovering unit 340, the water in the refrigerant flow pipe is discharged through the water outflow pipe 293. At this point, when the water temperature detected by the cooling water temperature sensor 296 is equal to or greater than 0° C., the control unit (not shown) applies electric power to the compressor 210 to operate the water-cooled air conditioner.

In addition, the cooling water temperature sensor 296 detects the water temperature and transmits the corresponding signal to the printed circuit board. The printed circuit board oppositely opens and closes the recovering closing valve 346 and the thaw blocking valve 350 to guide the flow of the refrigerant for the heating mode.

That is, in order to operate the water-cooled air conditioner with the heating mode, the thaw blocking valve 350 is opened and the recovering closing valve 346 is closed.

Accordingly, the refrigerant compressed by the compressor 210 is introduced into the outdoor liquid-phase pipe 262 through the first outlet port 344 of the three-way valve via the indoor unit 100, after which the refrigerant is heat-exchanged with the water while passing through the second heat exchanger 290.

Then, the heat exchanged refrigerant is directed into the accumulator 270 through the first and second outlet ports 244 and 246 of the four-way valve 240. In the accumulator 270, the liquid-phase refrigerant is filtered off and only the gas-phase refrigerant is introduced into the compressor 210, thereby completing the heating cycle.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A water-cooled air conditioner comprising:
a first heat exchanger where indoor air is heat-exchanged with refrigerant;
a compressor for compressing the refrigerant;
a plate-shaped second heat exchanger where the refrigerant compressed by the compressor is heat-exchanged with the water; and
a freeze-crack preventing unit that is provided at a side of the second heat exchanger to prevent the water in the second heat exchanger from freezing.

2. The water-cooled air conditioner according to claim 1, wherein the freeze-crack preventing unit is a heat unit for applying heat to the second heat exchanger.

3. The water-cooled air conditioner according to claim 2, wherein the heating unit is a heater that is wound around the second heat exchanger to generate the heat by being applied with an external electric power.

4. The water-cooled air conditioner according to claim 3, wherein the heater is a heat wire wound around the second heat exchanger at a water outlet side.

5. The water-cooled air conditioner according to claim 1, wherein the freeze-crack preventing unit is selectively operated when a temperature of the water in the second heat exchanger is lower than a reference temperature.

6. The water-cooled air conditioner according to claim 1, wherein the freeze-crack preventing unit is a refrigerant recovering unit for allowing a portion of the refrigerant discharged from the second heat exchanger and compressed in the compressor to be returned to the second heat exchanger.

7. The water-cooled air conditioner according to claim 6, wherein the refrigerant recovering unit comprises:
a three-way valve that is provided with a plurality of ports to convert a flow direction of the refrigerant and a refrigerant recovering pipe that is connected to one of the ports of the three-way valve to guide the refrigerant discharged from the compressor to the three-way valve; and
an outdoor liquid-phase pipe is provided at a side of the three-way valve to guide the refrigerant discharged from the three-way valve to the second heat exchanger.

8. The water-cooled air conditioner according to claim 7, wherein the three-way value is provided with an inlet port communicating with an outlet of the second heat exchanger, a first outlet port connected to an indoor unit where the indoor air is heat-exchanged, and a second outlet port communicating with the refrigerant recovering pipe.

9. The water-cooled air conditioner according to claim 2, wherein a cooling water temperature sensor is provided at a side of the second heat exchanger to detect a temperature of the water passing through the second heat exchanger.

10. The water-cooled air conditioner according to claim 7, wherein a recovering closing valve for controlling flow of the refrigerant by selectively closing the refrigerant recovering pipe.

11. A method of controlling a water-cooled air conditioner, comprising:
detecting a temperature of water passing through the heat exchanger;
comparing the detected temperature with a reference temperature; and
preventing the water in the heat exchanger from freezing by selectively operating a freeze-crack preventing unit in accordance the comparison result.

12. The method of claim 11, wherein the freeze-crack preventing unit operates when the detected temperature is equal to or lower than the reference temperature.

13. The method according to claim 12, wherein the reference temperature is 0° C.

14. The method according to claim 11, further comprising stopping a driving of the compressor according to the comparison result.

15. The method according to claim 14, wherein the compressor stops driving when the detected temperature is equal to or lower than the reference temperature.

16. The method according to claim 15, wherein the reference temperature is 0° C.

17. The method according to claim 11, wherein the freeze-crack preventing unit is a heating unit that is wound around the heat exchanger to generate heat.

18. The method according to claim 11, wherein the freeze-crack preventing unit is a refrigerant recovering unit for returning the refrigerant compressed in the compressor to the heat exchanger.
